(19) United States
(12) Patent Application Publication
(10) Pub. No.: US 2022/0000701 A1
(43) Pub. Date: Jan. 6, 2022

(54) ASSIST DEVICE

(71) Applicant: JTEKT CORPORATION, Osaka-shi (JP)

(72) Inventor: Yoshitaka YOSHIMI, Kashiba-shi (JP)

(73) Assignee: JTEKT CORPORATION, Osaka-shi (JP)

(21) Appl. No.: 17/305,343

(22) Filed: Jul. 6, 2021

(30) Foreign Application Priority Data
Jul. 6, 2020 (JP) 2020-116201

(51) Int. Cl. A61H 3/00; A61H 1/02

(52) U.S. Cl. CPC A61H 3/00; A61H 1/0244; A61H 2201/5069; A61H 2201/5007; A61H 2201/5061; A61H 2201/1652

(57) ABSTRACT

An assist device includes a first body-worn unit; second body-worn units; an actuator; a controller configured to obtain an assist parameter that determines assist torque to be generated, and perform control to operate the actuator at an output based on the assist parameter; and a tilt angle detection part configured to obtain tilt angle information on a tilt angle of an upper body of a user. The actuator includes arms; and swing angle detection parts configured to obtain swing angle information on swing angles of the arms that represent angles formed by the upper body and thighs of the user. The controller is configured to obtain the assist parameter based on the swing angle information and the tilt angle information.

### CROSS-REFERENCE TO RELATED APPLICATION

This application claims priority to Japanese Patent Application No. 2020-116201 filed on Jul. 6, 2020, incorporated herein by reference in its entirety.

### BACKGROUND

### 1. Technical Field

This disclosure relates to an assist device.

### 2. Description of Related Art

Various assist devices that are worn on the bodies of users (persons) to assist the users in tasks have been proposed. When lifting a heavy object, for example, a user of an assist device can perform the task with a smaller force (with less burden). One such assist device is disclosed in Japanese Unexamined Patent Application Publication No. 2019-206045 (JP 2019-206045 A). This device includes a first body-worn unit that is worn on the upper body of a user including his or her hips, second body-worn units that are worn on the right and left legs of the user, an actuator that generates assist torque for assisting the user in moving his or her hips relatively to his or her thighs and vice versa, and a controller that controls the actuator.

### SUMMARY

In the assist device disclosed in JP 2019-206045 A, the actuator includes driving units that are mounted on the first body-worn unit so as to be located on right and left sides of the hips of the user. The actuator further includes arms. Each arm has its leading end mounted on the second body-worn unit and its base end mounted on the driving unit, and swings back and forth around the base end. The swing angle of the arm is detected by a sensor, and the controller obtains an assist torque command value as an assist parameter based on the swing angle.

Thus, the assist torque command value is obtained based on the swing angles of the arms, i.e., the angles of the legs (thighs) of the user. The actuator operates at an output according to the command value to provide the user with an assist force. In this case, for example, when the user in an upright standing posture merely bends his or her knees to change his or her posture and not to perform an action of lifting a load etc., the swing angles of the arms change and the assist torque command value is obtained based on this change. As a result, the assist device generates assist torque and may thereby cause the user to have a feeling of discomfort.

This disclosure provides an assist device that can reduce the likelihood of causing the user to have a feeling of discomfort.

An assist device according to one aspect of this disclosure includes a first body-worn unit that is worn at least on hips of a user; second body-worn units that are worn on thighs of right and left legs of the user; an actuator that includes driving units mounted on the first body-worn unit so as to be located on right and left sides of the hips of the user, the actuator being configured to generate assist torque that assists the user in moving the hips of the user relatively to the thighs of the user and moving the thighs of the user relatively to the hips of the user; a controller configured to obtain an assist parameter that determines the assist torque to be generated, and perform control to operate the actuator at an output based on the assist parameter; and a tilt angle detection part configured to obtain tilt angle information on a tilt angle of an upper body of the user. The actuator includes arms each of which has a leading end mounted on a corresponding one of the second body-worn units and a base end mounted on a corresponding one of the driving units, each of the arms being configured to swing back and forth around the base end; and swing angle detection parts configured to obtain swing angle information on swing angles of the arms that represent angles formed by the upper body and the thighs of the user. The controller is configured to obtain the assist parameter based on the swing angle information and the tilt angle information.

In this assist device, not only the angles formed by the upper body and the thighs of the user, but also the tilt angle of the upper body of the user that is the degree of the forward leaning posture of the upper body is taken into account in obtaining the assist parameter. This makes it possible to control the actuator so as to generate no assist torque or, if any, only small assist torque, depending on the tilt angle of the upper body. As a result, the likelihood of causing the user to have a feeling of discomfort can be reduced.

To obtain the assist parameter, the controller may be configured to obtain a provisional assist parameter based on the swing angle information, obtain a correction gain based on the tilt angle information, and obtain the assist parameter using the provisional assist parameter and the correction gain. In this configuration, the assist parameter is obtained by obtaining the correction gain according to the tilt angle of the upper body and correcting the provisional assist parameter obtained based on the swing angle(s) of the arm(s).

The larger the tilt angle of the upper body of the user is, the greater the burden on the hips of the user tends to be. Therefore, a value of the correction gain obtained by the controller may be a value that makes the assist parameter larger when the tilt angle is large than when the tilt angle is small. In this configuration, when the tilt angle of the upper body is large, the assist parameter is set to a large value. As a result, large assist torque is generated and the burden on the hips of the user can be further relieved.

In the case where the controller obtains the provisional assist parameter such that, for example, the provisional assist parameter becomes larger as the swing angle becomes larger, when the user merely bends his or her knee a little, for example, to change his or her posture, swing angle information on a swing angle that is larger than zero may be obtained and a provisional assist parameter for generating assist torque that is larger than zero may be obtained. If the actuator is operated at an output based on this provisional assist parameter, the assist device provides the user with an assist force although the user merely changes his or her posture.

Therefore, the controller may be configured to, when the tilt angle is small, obtain the correction gain for causing the assist parameter to approach zero based on the tilt angle information on the tilt angle. In this configuration, even when a provisional assist parameter for generating assist torque that is larger than zero is obtained, the assist parameter can be caused to approach zero if the tilt angle is small. As a result, the user is prevented from being provided with an assist force when the user merely changes his or her posture.

The controller may include a counting part configured to obtain a lifting duration time indicating an elapsed time since the user starts to lift a load; a storage part configured to store first correspondence information that indicates a relation between the tilt angle information and the correction gain and second correspondence information that indicates a relation between the lifting duration time and the provisional assist parameter; a first processing part configured to obtain the correction gain based on the obtained tilt angle information and the first correspondence information; and a second processing part configured to obtain the provisional assist parameter based on the obtained lifting duration time and the second correspondence information. In this configuration, the provisional assist parameter is obtained according to the elapsed time since lifting of a load is started, so that the assist parameter is obtained according to that time.

The controller may be configured to obtain, as the assist parameter, a sum of a value that is obtained by applying a rigidity term gain to the obtained tilt angle information and a value that is obtained by applying a viscosity term gain to the obtained swing angle information. In this case, appropriate assist torque can be generated when, for example, the user lowers a load or merely assumes a forward leaning posture.

A process in which the controller obtains the assist parameter using the correction gain may be a process for lifting. A process in which the controller obtains, as the assist parameter, a sum of a value that is obtained by applying a rigidity term gain to the obtained tilt angle information and a value that is obtained by applying a viscosity term gain to the obtained swing angle information may be a process for a bowing action. The controller may be configured to select and perform one of the process for lifting and the process for the bowing action. In this case, the process for lifting and the process for bowing have different logics, and processes suitable for the respective actions are performed.

As a suitable configuration in which the tilt angle detection part and the swing angle detection parts detect the tilt angle and the swing angles, respectively, the tilt angle detection part may be a sensor configured to produce an output that varies according to a posture of the upper body of the user, and the swing angle detection parts may be detectors configured to detect rotation angles of rotating members provided in the actuator to swing the arms. This configuration makes it possible to accurately obtain the tilt angle information on the tilt angle of the upper body of the user and the swing angle information on the swing angles of the arms.

The assist device according to the above aspect of this disclosure can reduce the likelihood of causing the user to have a feeling of discomfort.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing the overall configuration of one example of an assist device;

FIG. 2 is an exploded perspective view of the assist device shown in FIG. 1;

FIG. 3 is a side view showing a user wearing the assist device shown in FIG. 1;

FIG. 4 is a side view showing the user wearing the assist device shown in FIG. 1;

FIG. 5 is an exploded view of a right driving unit;

FIG. 6 is a sectional view of the right driving unit;

FIG. 7 is a block diagram showing a control device etc. included in the assist device;

FIG. 8 is a block diagram showing one example of processes performed by a control device;

FIG. 9 is a flowchart showing the one example of the processes performed by the control device;

FIG. 10 is a block diagram showing another example of the processes performed by the control device;

FIG. 11 is a flowchart showing the other example of the processes performed by the control device; and

FIG. 12 is a perspective view showing an assist device in another form.

### DETAILED DESCRIPTION OF EMBODIMENTS

Overall Structure of Assist Device

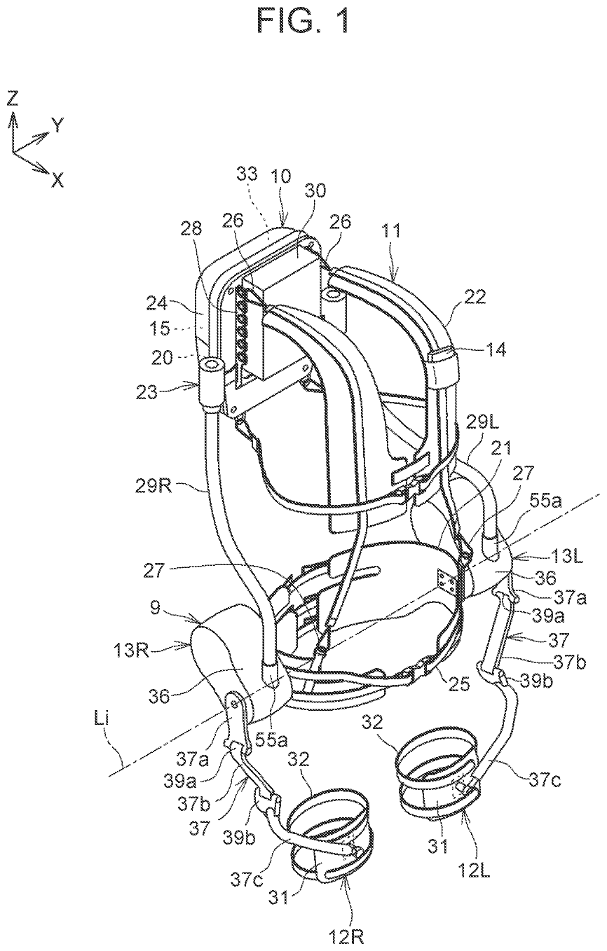

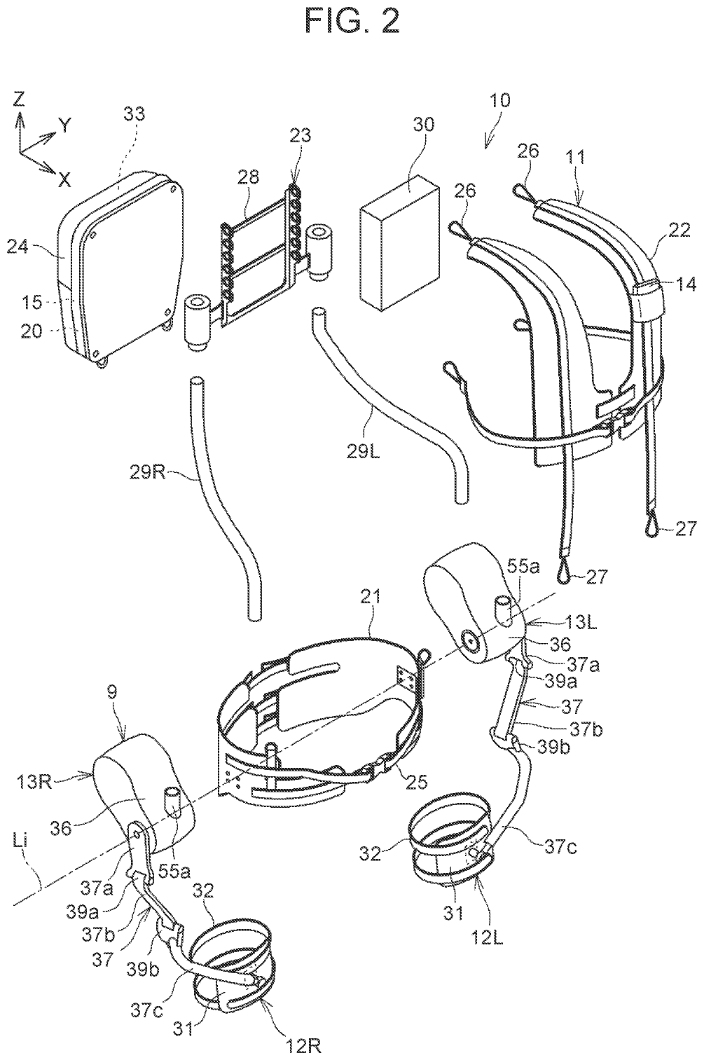

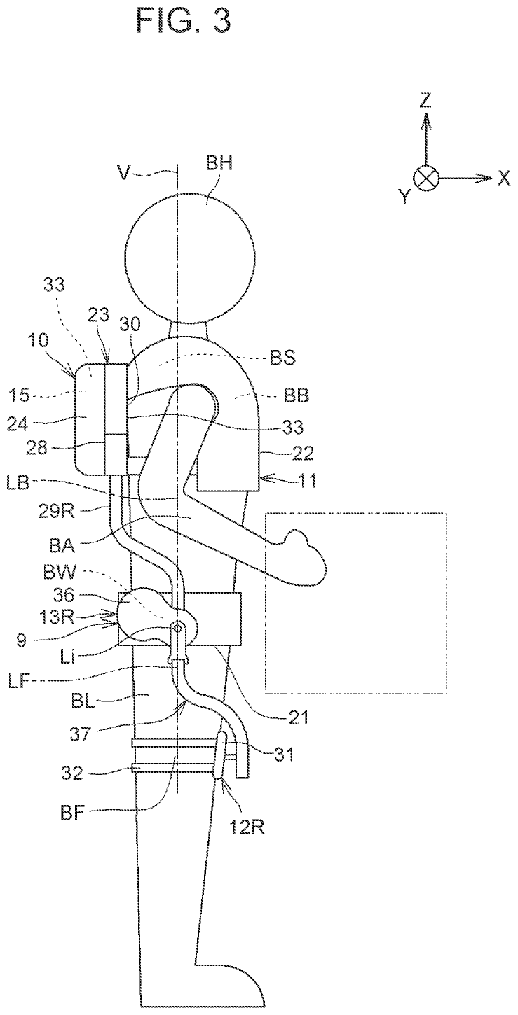

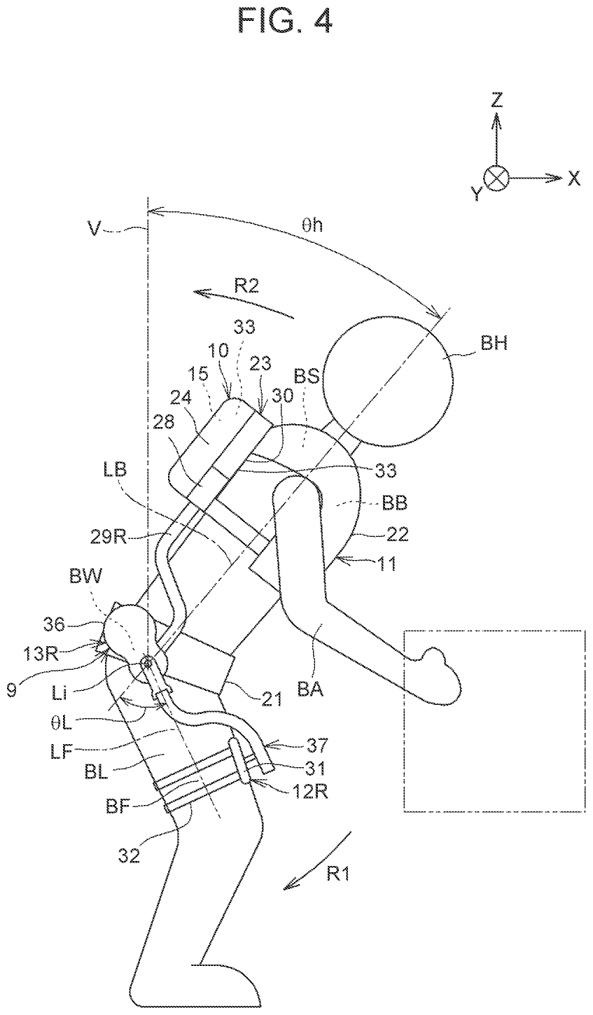

FIG. 1 is a perspective view showing the overall configuration of one example of an assist device. FIG. 2 is an exploded perspective view of the assist device shown in FIG. 1. FIG. 3 and FIG. 4 are side views showing a user wearing the assist device shown in FIG. 1. In FIG. 3, the user is in an upright standing posture, and in FIG. 4, the user is in a forward leaning posture. The upright standing posture shown in FIG. 3 is a posture in which a longitudinal direction of the body of the user from his or her leg BL to his or her head BH extends along a vertical line V The forward leaning posture shown in FIG. 4 is a posture in which a longitudinal direction of the upper body of the user from his or her hips BW to his or her head BH tilts toward a front side relatively to the vertical line V The forward leaning posture shown in FIG. 4 is a posture of the user in a state of having bent his or her legs BL at the knees. In FIG. 4, the angle of the forward leaning posture of the upper body of the user relative to the vertical line V is denoted by θh. In this disclosure, the angle θh is defined as a “tilt angle θh.”

An assist device 10 is a device that assists a user in turning his or her legs BL (thighs BF) relatively to his or her hips BW, for example, when the user lifts a load and lowers a load, and assists the user in turning his or her legs BL (thighs BF) relatively to his or her hips BW when the user walks. Operation of the assist device 10 providing the user with physical assistance will be referred to as “assist operation.”

The X-axis, Y-axis, and Z-axis in the drawings are orthogonal to each other. For the user who is wearing the assist device 10 in an upright standing posture, an X-axis direction, a Y-axis direction, and a Z-axis direction correspond to a frontward direction, a leftward direction, and an upward direction, respectively. With regard to assist operation, assisting the user in turning his or her legs BL (thighs BF) relatively to his or her hips BW as mentioned above is the same as assisting the user in turning his or her hips BW relatively to his or her legs BL (thighs BF). Assist operation is operation of assisting the user by providing the user with torque around an imaginary line Li that passes through the user near his or her hips BW in a right-left direction. This torque will be also referred to as “assist torque.”

The assist device 10 shown in FIG. 1 includes a first body-worn unit 11, right and left second body-worn units 12R, 12L, and an actuator 9 that generates assist torque for assisting the user in moving his or her hips BW relatively to his or her thighs BF and vice versa. “Moving his or her hips BW relatively to his or her thighs BF and vice versa” means moving his or her thighs BF relatively to his or her hips BW and moving his or her hips BW relatively to his or her thighs BF. In the form shown in FIG. 1, the actuator 9 includes right and left driving units 13R, 13L.

The first body-worn unit 11 includes a hip support 21 and a jacket 22 and is worn on the upper body of the user including at least his or her hips BW. The right and left second body-worn units 12R, 12L are worn on the right and left thighs BF of the user. The right and left driving units 13R, 13L are interposed between the first body-worn unit 11 and the second body-worn units 12R, 12L and serve as driving parts that perform driving operation to perform assist operation.

The assist device 10 further includes an operation unit 14 and a control device 15. The operation unit 14 is a so-called controller and is a device into which the user inputs specifications of assist operation etc. The specifications of assist operation include an action mode of assist operation, the intensity of assist operation, and the speed of assist operation. Action modes may include, for example, “lowering action” and “lifting action” and may further include “walking.” The intensity of assist operation is set in multiple levels. For example, “level 1 (low),” “level 2 (medium),” and “level 3 (high)” are set. The operation unit 14 is provided with selection buttons by which the user selects the specifications of assist operation. The operation unit 14 is attached to the first body-worn unit 11, for example, to the jacket 22. The operation unit 14 and the control device 15 are connected to each other via wire or wirelessly and can communicate with each other. The control device 15 controls the operation of the driving units 13R, 13L according to the information input into the operation unit 14.

The first body-worn unit 11 includes the hip support 21, the jacket 22, a frame 23, and a backpack 24. The hip support 21 is worn around the hips BW of the user. The hip support 21 includes a belt 25. The belt 25 allows the length of the hip support 21 around the hips BW to be changed and is used to fix the hip support 21 to the hips BW. The hip support 21 includes a hard core made of resin or the like and a leather or fabric member. Cases 36 of the driving units 13R, 13L are mounted on right and left sides of the hip support 21. The hip support 21 and the cases 36 are mounted so as to be able to turn in one direction and the other direction around the imaginary line Li extending in the right-left direction.

The jacket 22 is worn around the shoulders BS and the chest BB of the user. The jacket 22 includes first mounting parts 26 and second mounting parts 27. The jacket 22 is coupled to the frame 23 by the first mounting parts 26. The jacket 22 is coupled to the hip support 21 by the second mounting parts 27. The jacket 22 includes a hard core made of resin or the like and a leather or fabric member.

The frame 23 is formed by a member made of metal, such as aluminum alloy. The frame 23 includes a main frame 28, a left sub-frame 29L, and a right sub-frame 29R. The main frame 28 includes a support member 30 on which the back of the user rests. The right sub-frame 29R and the left sub-frame 29L are columnar members that connect the main frame 28 and parts of the right and left driving units 13R, 13L to each other. An upper end of the left sub-frame 29L is coupled to a part of the main frame 28, and a lower end of the left sub-frame 29L is coupled to the case 36 of the left driving unit 13L. An upper end of the right sub-frame 29R is coupled to another part of the main frame 28, and a lower end of the right sub-frame 29R is coupled to the case 36 of the right driving unit 13R. Thus, the right and left driving units 13R, 13L and the frame 23 of the first body-worn unit 11 are integrated, so that the right and left driving units 13R, 13L and the frame 23 (first body-worn unit 11) cannot shift relatively to each other.

The backpack 24 is mounted at a back part of the main frame 28. The backpack 24 is also called a control box and has a box shape, and inside the backpack 24, the control device 15, a power source (battery) 20, an acceleration sensor 33, and others are provided. The power source 20 supplies required electricity to pieces of equipment including the control device 15 and the right and left driving units 13R, 13L.

The right and left second body-worn units 12R, 12L are worn around the right and left thighs BF of the user. The shape of the second body-worn unit 12L for the left thigh BF and the shape of the second body-worn unit 12R for the right thigh BF are mirror images of each other, but both units have the same configuration. The second body-worn unit 12L (12R) includes a pad-like main part 31 formed by a hard core made of metal, resin, or the like and a belt 32 formed by a leather or fabric member. A part of an arm 37 of the driving unit 13L is coupled to the main part 31. The main part 31 comes into contact with a front surface of the thigh BE. The belt 32 allows the length of the second body-worn unit 12R (12L) around the thigh BF to be changed and is used to fix the main part 31 to the thigh BE.

The left driving unit 13L is provided between the first body-worn unit 11 and the second body-worn unit 12L. The right driving unit 13R is provided between the first body-worn unit 11 and the right second body-worn unit 12R. The right and left driving units 13R, 13L are mounted on the first body-worn unit 11 so as to be located on right and left sides of the hips BW of the user. Specifically, the driving units 13R, 13L are mounted on the right and left sides of the hip support 21. The shape of the left driving unit 13L and the shape of the right driving unit 13R are mirror images of each other, but both units have the same configuration and the same function. The left driving unit 13L and the right driving unit 13R can each operate independently of the other and perform a different operation, as well as can synchronously perform the same operation.

Each of the right and left driving units 13R, 13L has a configuration for performing assist operation of providing the user with an assist force. The assist force is torque around the imaginary line Li, and this torque is “assist torque.” The assist device 10 assists the user in turning his or her thighs BF relatively to his or her hips BW with assist torque output by the right and left driving units 13R, 13L.

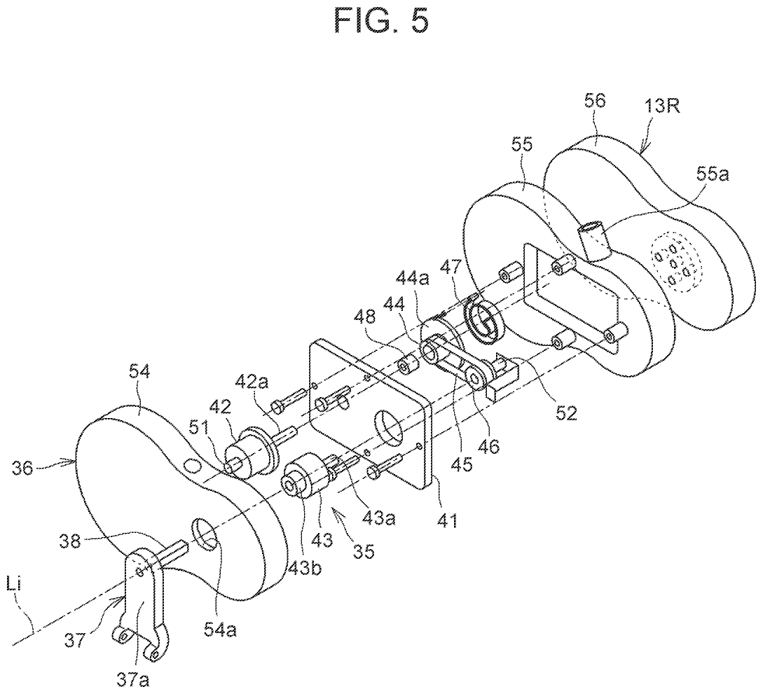

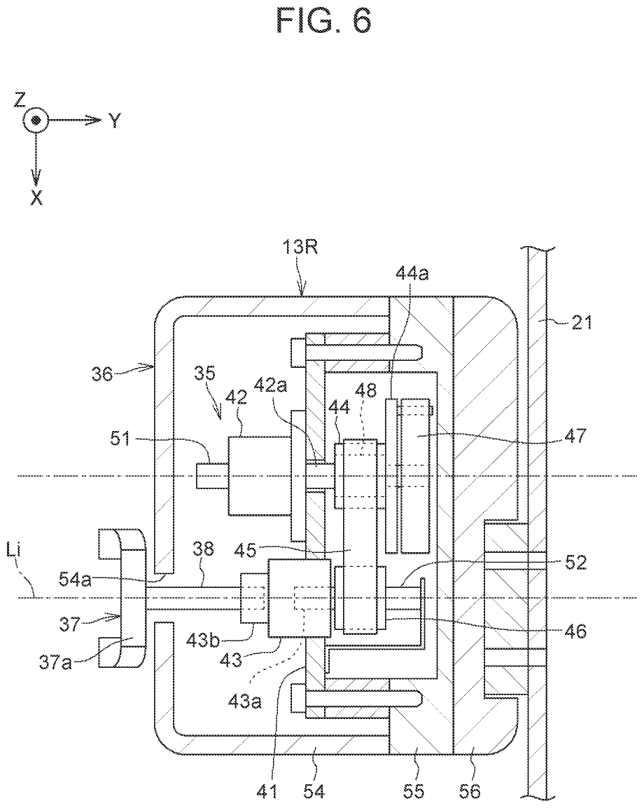

FIG. 5 is an exploded view of the right driving unit 13R. FIG. 6 is a sectional view of the right driving unit 13R. Since the left driving unit 13L and the right driving unit 13R have the same configuration, the configuration of the right driving unit 13R will be described and the description of the left driving unit 13L will be omitted here. The driving unit 13R includes a driving mechanism 35, the case 36 that houses the driving mechanism 35, and the arm 37 to which torque output from the driving mechanism 35 is transmitted. In FIG. 5 and FIG. 6, only a part (first arm part 37a) of the arm 37 is shown.

An assist shaft 38 is fixed at an upper end of the arm 37 (first arm part 37a), and the arm 37 and the assist shaft 38 rotate integrally. The assist shaft 38 is provided in the driving unit 13R so as to be centered on the imaginary line Li. As shown in FIG. 1, a leading end of the arm 37 (third arm part 37c) is coupled to the second body-worn unit 12R.

The driving mechanism 35 is configured as follows. The driving mechanism 35 provides the user with assist torque by swinging (turning) the arm 37 around the imaginary line Li. When the user voluntarily changes his or her posture (see FIG. 3 and FIG. 4), the arm 37 swings (turns) around the imaginary line Li relatively to the case 36.

The specific configuration of the driving mechanism 35 will be described. As shown in FIG. 5 and FIG. 6, the driving mechanism 35 includes a sub-frame 41 that is fixed on the case 36, a motor 42, a speed reducer 43, a first pulley 44 having a flange 44a, a transmission belt 45, a second pulley 46, a spiral spring 47, a bearing 48, a first detector 51, and a second detector 52. The motor 42, the speed reducer 43, and the second detector 52 are mounted on the sub-frame 41. The first pulley 44 is mounted on an output shaft 42a of the motor 42 through the bearing 48, and the first pulley 44 can rotate relatively to the output shaft 42a. An inner peripheral end of the spiral spring 47 is mounted on a leading part of the output shaft 42a. An outer peripheral end of the spiral spring 47 is mounted on the flange 44a of the first pulley 44. The assist shaft 38 is fixed on a speed reducing shaft 43b of the speed reducer 43. The second pulley 46 is mounted on a speed increasing shaft 43a of the speed reducer 43. The transmission belt 45 is wrapped around the first pulley 44 and the second pulley 46. Central axes of the assist shaft 38, the speed reducer 43, and the second pulley 46 coincide with the imaginary line Li.

The case 36 has a split structure. The case 36 includes an outer case 54, a middle case 55, and an inner case 56. The inner case 56 is mounted on the hip support 21 so as to be turnable around the imaginary line Li. The assist shaft 38 is disposed so as to extend through a hole 54a provided in the outer case 54. The middle case 55 includes a mounting part 55a to which the right sub-frame 29R is mounted.

The first detector 51 detects the rotation angle of the output shaft 42a of the motor 42. The second detector 52 directly detects the rotation angle of the second pulley 46. Since the reduction ratio of the speed reducer 43 is constant, the second detector 52 can detect the turning angle of the assist shaft 38. The turning angle of the assist shaft 38 and the swing angle (turning angle) of the arm 37 are the same, and therefore the second detector 52 can detect the swing angle of the arm 37.

In the upright standing posture shown in FIG. 3, a straight line LB in the longitudinal direction of the upper body of the user and a straight line LF in the longitudinal direction of the thigh BF of the user extend along the common vertical line V. As shown in FIG. 4, in the posture in which the user leans forward with his or her knees bent, the straight line LB tilts relatively to the vertical line V, and the angle of this tilt is the “tilt angle θh.” The straight line LB in the longitudinal direction of the upper body of the user and the straight line LF in the longitudinal direction of the thigh BF of the user intersect with each other at an angle θL. Since the arm 37 is provided to extend along the thigh BF of the user, the angle formed by the upper body and the thigh BF of the user is the same as the swing angle of the arm 37. In other words, the swing angle of the arm 37 represents the angle θL.

The second detector 52 of the driving unit 13R shown in FIG. 5 can obtain swing angle information on the swing angle θL of the arm 37 with respect to the straight line LB in the longitudinal direction of the upper body of the user. The second detector 52 functions as a swing angle detection part that obtains the swing angle information on the swing angle θL of the arm 37. Since the swing angle θL of the arm 37 corresponds to the rotation angle (swing angle) of the femur relative to the pelvis, the swing angle θL of the arm 37 may be hereinafter referred to as “the rotation angle θL of the hip joint” of the user.

The first detector 51 and the second detector 52 are formed by encoders, angle sensors, or the like. The first detector 51 and the second detector 52 are provided in each of the driving units 13R, 13L and function as detectors for the thigh BF of the right leg and detectors for the thigh BF of the left leg. Detection results of the first detectors 51 and the second detectors 52 are output to the control device 15. The detection result of each first detector 51 should be rotation angle information on the rotation angle of the output shaft 42a, and in this embodiment, this information is the rotation angle itself. The detection result of each second detector 52 should be swing angle information on the swing angle of the arm 37, and in this embodiment, this information is the swing angle θL itself.

As described above (see FIG. 1), the frame 23 of the first body-worn unit 11 and the right and left driving units 13R, 13L are integrated and cannot shift relatively to each other. When the user changes his or her posture (see FIG. 3 and FIG. 4), the right and left arms 37 turn around the imaginary line Li relatively to the cases 36 of the right and left driving units 13R, 13L. Thus, when the user changes his or her posture, torque is applied to the arms 37. This torque is transmitted from each arm 37 to the second pulley 46 through the assist shaft 38 and the speed reducer 43. The torque transmitted to the second pulley 46 is transmitted to the spiral spring 47 through the transmission belt 45 and the first pulley 44. The torque that is transmitted from the arm 37 through the assist shaft 38 as a result of a change in the posture of the user is accumulated in the spiral spring 47.

When the motor 42 rotates, torque of the motor 42 (motor torque) is accumulated in the spiral spring 47. Thus, in the spiral spring 47, the torque of the motor 42 as well as the user's torque transmitted by an action of the user are accumulated. Combined torque combining the assist torque and the user's torque is accumulated in the spiral spring 47. The combined torque accumulated in the spiral spring 47 is output to the assist shaft 38 through the first pulley 44, the transmission belt 45, the second pulley 46, and the speed reducer 43, and swings the arm 37. Torque that the driving units 13R, 13L output with the use of the torque of the motor 42 is “assist torque” provided by the assist device 10.

The combined torque is obtained based on an amount of change in the angle of the spiral spring 47 from a no-load state and the spring constant of the spiral spring 47. The amount of change in the angle is correlated with the sum of an amount of change in the rotation angle of the output shaft 42a of the motor 42 and an amount of change in the rotation angle of the assist shaft 38. Therefore, the combined torque is obtained based on a detection result of the first detector 51, a detection result of the second detector 52, and the spring constant of the spiral spring 47. As the detection results of the first detector 51 and the second detector 52 are provided to a processing unit 16 included in the control device 15, the processing unit 16 can obtain the combined torque.

As shown in FIG. 1 and FIG. 2, each arm 37 includes a plurality of arm parts and joints that couple these arm parts together. In this disclosure, each arm 37 includes the first arm part 37a, a second arm part 37b, the third arm part 37c, a first joint 39a, and a second joint 39b. The first joint 39a couples the first arm part 37a and the second arm part 37b on both sides of the first joint 39a together so as to allow them to bend around a central axis that is skew to the imaginary line Li and so as not to allow them to bend around a central axis parallel to the imaginary line Li. The second joint 39b couples the second arm part 37b and the third arm part 37c on both sides of the second joint 39b together so as to allow them to bend around a central axis that is skew to the imaginary line Li and so as not to allow them to bend around a central axis parallel to the imaginary line Li. A lower end of the third arm part 37c is mounted on the main part 31 of the second body-worn unit 12R (12L) so as to be able to bob. This configuration allows the second body-worn unit 12R (12L) to be securely mounted on the thigh BF of the user according to his or her body size, and also facilitates a walking action etc.

The arm 37 includes the joints 39a, 39b but can transmit torque around the imaginary line Li to the second body-worn unit 12R (12L). When the user changes his or her posture (see FIG. 3 and FIG. 4), the second body-worn unit 12R (12L) is pressed by the thigh BF and the arm 37 swings around the imaginary line Li. Thus, the arm 37 can transmit a force that an action (a change in the posture) of the user exerts on the second body-worn unit 12R (12L) to the assist shaft 38 as torque around the imaginary line Li. The arm 37 may have a form different from that shown in the drawings.

As has been described above, the actuator 9 includes the right and left arms 37, and the second detectors 52 that obtain the swing angle information on the swing angles θL of the arms 37. Each arm 37 has its leading end mounted on the second body-worn unit 12 and its base end mounted on the assist shaft 38 of the driving unit 13L (13R), and swings back and forth around the base end. In the following description, the second detector 52 will be referred to as a “swing angle sensor 52.”

The assist device 10 further includes a tilt angle detection part that obtains tilt angle information on the tilt angle of the upper body of the user that is an upper part of the user's body including his or her hips BW. The tilt angle detection part in this embodiment is a triaxial acceleration sensor (tilt angle sensor) 33. The acceleration sensor 33 is provided, for example, in the backpack 24. The tilt angle of the upper body of the user refers to the tilt angle with respect to the vertical line V when the user leans toward the front side, and in this disclosure (see FIG. 4), this tilt angle is denoted by “θh” as described above. A detection result of the acceleration sensor 33 should be tilt angle information on the tilt angle of the upper body of the user, and in this embodiment, this information is the tilt angle itself. The tilt angle detection part may have another form as long as it is configured to, like the triaxial acceleration sensor 33, output a signal corresponding to the posture (tilt angle) of the upper body of the user.

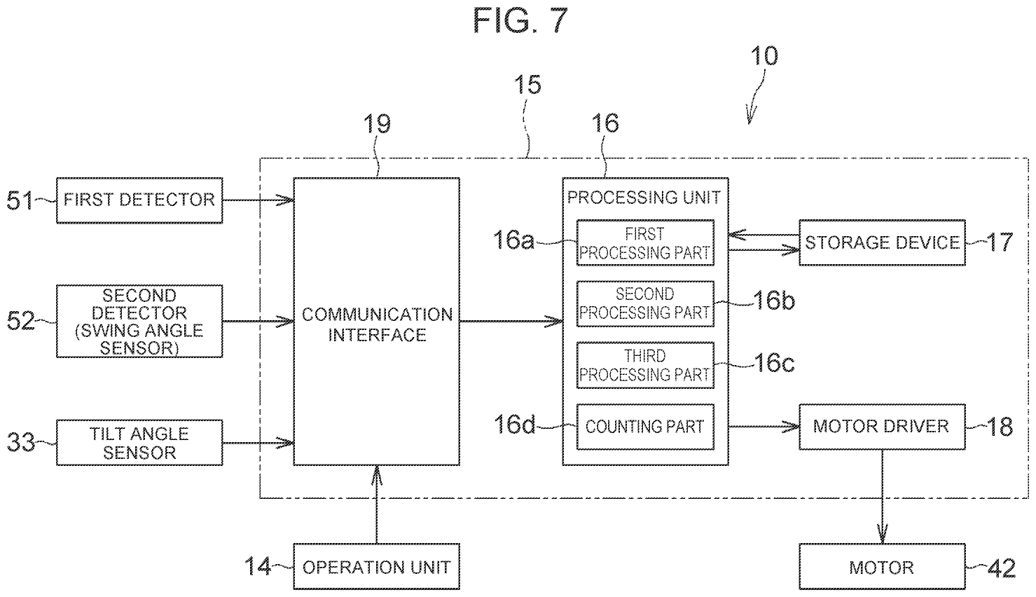

FIG. 7 is a block diagram showing the control device 15 etc. included in the assist device 10. The control device 15 obtains an assist torque command value as an assist parameter for determining assist torque to be generated, and performs control to operate the actuator 9 at an output based on the command value. The assist parameter may be any parameter that determines assist torque to be generated, and a parameter other than torque, for example, an assist force, may be used as the assist parameter.

To obtain the assist torque command value and control the actuator 9, the control device 15 includes the processing unit (processing device) 16 including a central processing unit (CPU), a storage device 17 formed by a non-volatile memory or the like that stores information, such as various programs and databases, a motor driver 18, and a communication interface 19.

The processing unit 16 can have various functions by executing computer programs stored in the storage device 17. The processing unit 16 functions to obtain an assist torque command value as an assist parameter and to provide commands for performing assist operation with the use of the driving units 13R, 13L. Specifically, as functional parts that operate in accordance with computer programs stored in the storage device 17, the processing unit 16 includes a first processing part 16a that obtains a correction gain to be described later, a second processing part 16b that obtains a provisional assist torque command value, a third processing part 16c that obtains an assist torque command value, and a counting part 16d that obtains a lifting duration time indicating an elapsed time since the user starts to lift a load. Specific processes performed by these functional parts will be described later.

The function of giving commands for performing assist operation with the use of the driving units 13R, 13L will be described. For example, when a selection button of the operation unit 14 (see FIG. 7) is selected by the user, the processing unit 16 performs assist operation in accordance with a program for the action corresponding to that selection button. The processing unit 16 functions to perform assist operation for a “lowering action,” a “lifting action,” etc. in accordance with programs stored in the storage device 17. The processing unit 16 functions to, when detecting “walking” as the action mode, perform assist operation for “walking” in accordance with a program stored in the storage device 17. The walking action is detected (determined) based on a detection result of one or both of the triaxial acceleration sensor 33 and the swing angle sensors 52. As the programs, a walking program, a lifting program, and a lowering program are stored in the storage device 17. For example, when a button in the operation unit 14 corresponding to a “lifting action” is selected by the user's operation, the processing unit 16 performs assist operation for a lifting action in accordance with the lifting program.

In the case where the assist device 10 provides assistance for “walking,” a “lifting action,” or a “lowering action,” the processing unit 16 obtains a command value for the required assist torque, and generates a command signal that causes the driving units 13R, 13L to output assist torque corresponding to that command value. This command signal is provided to the motor driver 18. The motor driver 18 is configured to include an electronic circuit, for example, and outputs a driving current for driving the motor 42 based on the command signal from the processing unit 16. The motor driver 18 activates the driving units 13R, 13L based on the command signal. The motor driver 18 functions as an activation control part that activates the driving units 13R, 13L based on the signal (command signal) corresponding to the assist torque command value.

As will be described later, in some cases, the assist torque command value is obtained based on a predetermined gain. In this embodiment, the value of the gain is determined when the user selects a selection button for the intensity of assist operation. The selection button is provided in the operation unit 14.

Signals from each of the operation unit 14, the first detectors 51, the second detectors (swing angle sensors 52), and the acceleration sensor 33 are input into the communication interface 19, which then provides these signals to the processing unit 16. Information input into the operation unit 14, such as the specifications of assist operation, is input into the processing unit 16 through the communication interface 19, and the processing unit 16 performs processes using the input information.

Overview of Assist Operation

As described above, the assist device 10 performs assist operation by operating the right and left driving units 13R, 13L. Assist operation is operation of providing assist torque around the imaginary line Li passing through the user near his or her hips BW in the right-left direction to the user through the first body-worn unit 11 and the second body-worn units 12R, 12L.

Examples of actions of the user include: an upright standing action (also called a “lifting action”) in which the user changes the posture of his or her upper body from a forward leaning posture to an upright standing posture to lift a load; a forward leaning action (also called a “lowering action”) in which the user changes the posture of his or her upper body from an upright standing posture to a forward leaning posture to lower a load; and an action in which the user walks.

Regardless of whether the user performs a lifting action or a lowering action, assist torque generated by the assist device 10 is torque in a direction of changing the posture of the user from a forward leaning posture to an upright standing posture. That is, the direction in which the right and left driving units 13R, 13L try to turn (swing) the arms 37 around the imaginary line Li (see FIG. 4) is the direction of arrow R1, and the direction in which the right and left driving units 13R, 13L try to turn the first body-worn unit 11 (frame 23) around the imaginary line Li is the direction of arrow R2. For example, when the user performs a lifting action, the pad-like main parts 31 of the right and left second body-worn units 12R, 12L push the right and left thighs BF backward by assist torque in the direction of arrow R1. The frame 23 of the first body-worn unit 11 pulls the upper body of the user toward the back side (backward) by assist torque in the direction of arrow R2.

When the assist device 10 performs assist operation for walking on the user, this assist operation is operation of assisting the user in turning his or her thighs BF relatively to his or her hips BW, and the right and left driving units 13R, 13L alternately perform the operation to assist turning. Thus, the right and left driving units 13R, 13L alternately swing the right and left arms 37 at predetermined assist torque.

Process of Obtaining Assist Torque as Assist Parameter

The command value for the assist torque that is output by the driving units 13R, 13L for the assist device 10 configured as described above to perform assist operation is determined by the processing unit 16. The assist torque that the driving units 13R, 13L provide to the user is based on the output torque of the motor 42. To increase the assist torque provided to the user, the output torque of the motor 42 should be increased, and to reduce the assist torque provided to the user, the output torque of the motor 42 should be reduced. As will be described using an example later, the assist torque command value is obtained by the processing unit 16 based on various pieces of information obtained from the swing angle sensors 52, the acceleration sensor 33, etc. In the following, a specific example of the process of obtaining the assist torque command value will be described.

Example of Process for Assist Operation

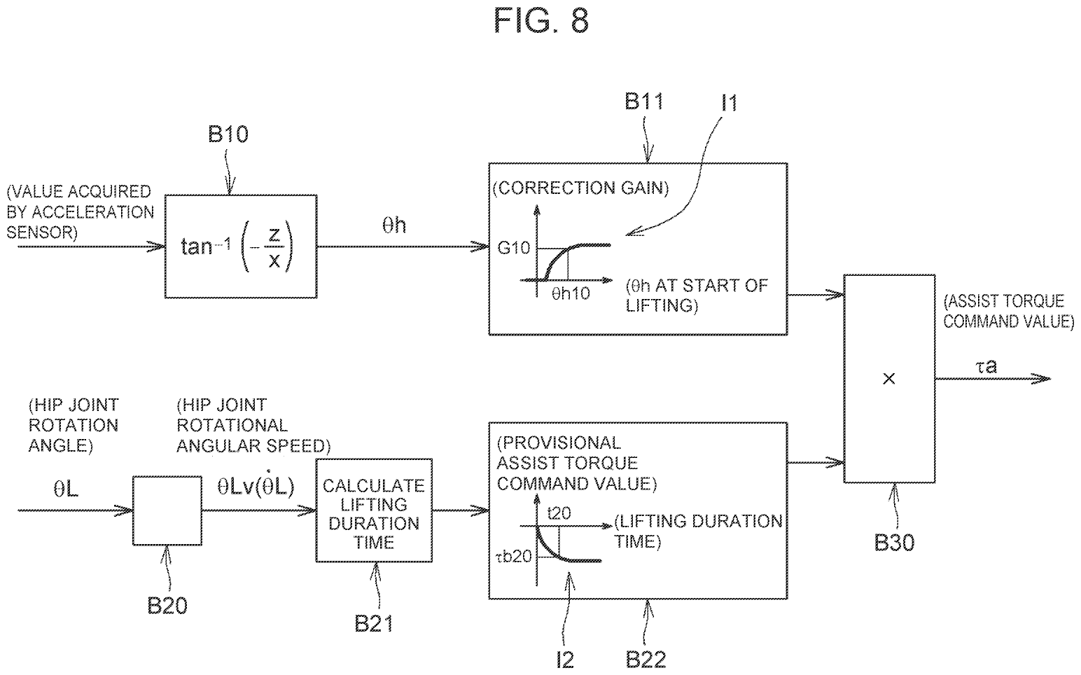

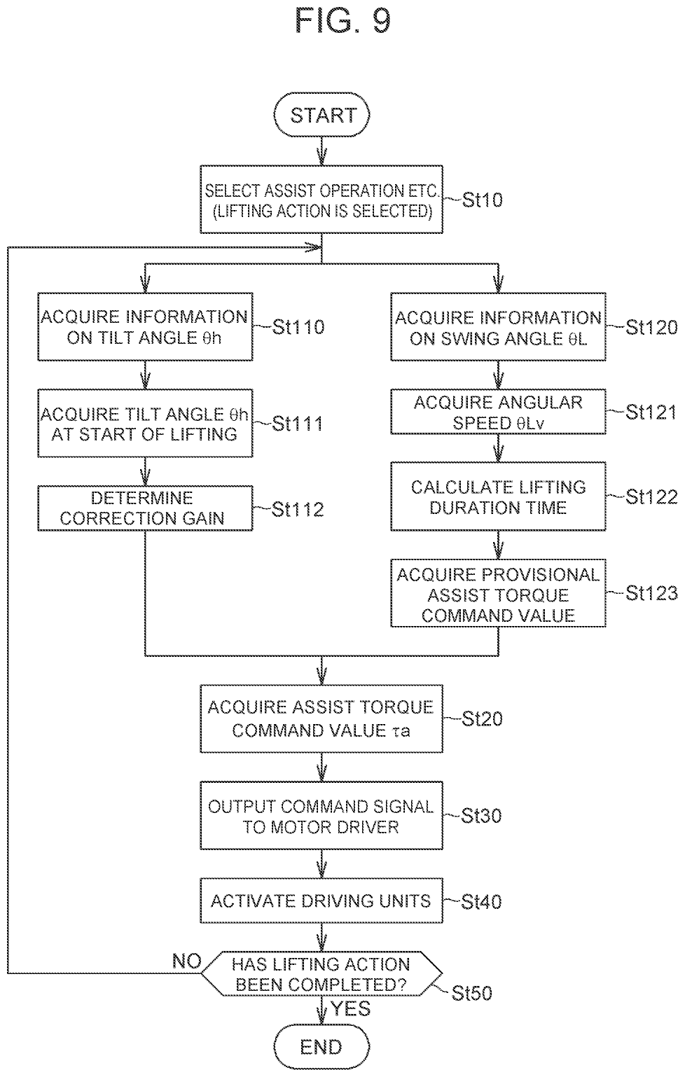

FIG. 8 is a block diagram showing one example of processes performed by the control device 15, and FIG. 9 is a flowchart showing the one example of the processes. The process shown in FIG. 8 and FIG. 9 is a process for lifting, which is a process of, when the user wearing the assist device 10 lifts a load, providing the user with assist torque in a direction of lifting the load. FIG. 8 shows a process of obtaining a command value τa for this assist torque. The process for lifting is performed when “lifting action” is selected in the operation unit 14 as shown in step St10 of FIG. 9.

As shown in step St20 of FIG. 9, when the command value τa is obtained, a command signal for causing the driving units 13R, 13L to output assist torque corresponding to the command value τa is provided to the motor driver 18 as described above (step St30). The motor driver 18 activates the driving units 13R, 13L based on the command signal (step St40). Thus, assist torque is provided to the user.

Process for Lifting

In FIG. 9, a process of acquiring the tilt angle information on the tilt angle θh obtained by the triaxial acceleration sensor 33 (step St110), and a process of acquiring the swing angle information on the swing angle θL obtained by the swing angle sensor 52 (step St120) are performed. In this embodiment, the tilt angle information on the tilt angle θh is the tilt angle θh, and the swing angle information on the swing angle θL is the swing angle θL. The assist torque command value τa is obtained based on these pieces of information, i.e., the tilt angle θh and the swing angle θL (step St20), and the driving units 13R, 13L are activated based on the command value τa (step St40). This cycle shown in FIG. 9, i.e., the sequence of processes shown in FIG. 9 is repeatedly performed in a predetermined cycle (e.g., the sequence of processes is performed every 0.001 seconds) until the lifting action is completed. The process for lifting for the right driving unit 13R and the process for lifting for the left driving unit 13L are the same and concurrently performed.

The storage device 17 stores first correspondence information I1 and second correspondence information 12 shown in FIG. 8. The first correspondence information I1 is information that indicates a relation between the tilt angle θh and a correction gain. In FIG. 8, the “tilt angle θh” is described as “θh at start of lifting.” The second correspondence information 12 is information that indicates a relation between a lifting duration time and a provisional assist torque command value.

In FIG. 8, the first processing part 16a acquires the tilt angle θh of the user by calculations based on a detection signal of the triaxial acceleration sensor 33 (block B10 of FIG. 8 and step St110 of FIG. 9). The first processing part 16a obtains the correction gain for lifting assistance based on the obtained tilt angle θh and the first correspondence information I1 (block B11 of FIG. 8).

In this embodiment, the “tilt angle θh” used in block B11 is the “tilt angle θh at start of lifting.” For example, when the time-based change in the tilt angle θh switches from positive to negative, the processing unit 16 determines that lifting has started. Specifically, when the time-based change in the tilt angle θh changes from positive (a direction from upright standing to forward leaning) to negative (a direction from forward leaning to upright standing), the processing unit 16 determines that lifting has started. The tilt angle θh used to determine the switching from positive to negative is the “tilt angle θh at start of lifting.” Thus, the first processing part 16a performs a process of acquiring the tilt angle θh at the start of lifting (step St111 of FIG. 9).

The correction gain is obtained based on the tilt angle θh at the start of lifting and the first correspondence information I1 (block B11 of FIG. 8 and step St112 of FIG. 9). In the example shown in FIG. 8, the tilt angle at the start of lifting is “θh10,” and the correction gain is obtained as “G10.” The obtained correction gain is temporarily stored in the storage device 17.

In FIG. 8, when the swing angle θL (hereinafter referred to as “the rotation angle θL of the hip joint”) is obtained by the swing angle sensor 52, the processing unit 16 obtains a rotational angular speed θLv (block B20 of FIG. 8 and step St121 of FIG. 9). For example, the rotational angular speed θLv of the hip joint is obtained based on a time-based change in the rotation angle θL of the hip joint.

The counting part 16d obtains a “lifting duration time” indicating an elapsed time since the user starts to lift the load (block B21 of FIG. 8 and step St122 of FIG. 9). As described above, the process of obtaining the assist torque command value ta is repeatedly performed at predetermined time intervals (e.g., once every 0.001 seconds) until the lifting action is completed. The “lifting duration time” is a time obtained by multiplying a time for performing the process of obtaining the command value τa once (cycle: 0.001) by a weight coefficient, each time this process is performed, and then adding up the values obtained by the multiplication from the start of lifting. The weight coefficient is a variable, and is, for example, a value determined according to the time-based change in the rotation angle θL of the hip joint, i.e., the rotational angular speed θLv of the hip joint.

When the lifting duration time is obtained, the second processing part 16b obtains the provisional assist torque command value based on the lifting duration time and the second correspondence information 12 (block B22 of FIG. 8 and step St123 of FIG. 9). In this embodiment, the value of assist torque in the direction in which the user changes his or her posture from an upright standing posture to a forward leaning posture is a positive value. Therefore, the provisional assist torque command value for the lifting action that is obtained based on the second correspondence information 12 shown in FIG. 8 is a negative value. In the example shown in FIG. 8, the lifting duration time is “t20,” and the provisional assist torque command value is obtained as “τb20.” The obtained provisional command value is temporarily stored in the storage device 17.

When the provisional assist torque command value (τb20) is obtained based on the rotation angle θL of the hip joint (the swing angle θL of the arm 37) as described above, and the correction gain (G10) is obtained based on the tilt angle θh at the start of lifting as described above, the third processing part 16c obtains the command value ta for assist torque for the lifting action based on the provisional command value (τb20) and the correction gain (G10) (block B30 of FIG. 8 and step St20 of FIG. 9). In this embodiment, the command value τa is obtained by multiplying the provisional command value (Tb20) by the correction gain (G10).

As shown in FIG. 8, in the first correspondence information I1, the correction gain (which is a value equal to or larger than zero) is set to become larger as the tilt angle θh at the start of lifting becomes larger. Thus, the value of the correction gain is a value that makes the command value larger when the tilt angle θh is large than when the tilt angle θh is small. This is because the larger the tilt angle θh of the upper body is, the greater the burden on the hips BW is. In this configuration, when the tilt angle θh of the upper body is small, the assist torque command value τa is set to a small value, and when the tilt angle θh of the upper body is large, the assist torque command value τa can be set to a large value to relieve the burden on the hips BW. The second correspondence information 12 is set such that the provisional command value (assist torque) becomes larger as the lifting duration time becomes longer.

In the process of acquiring the provisional assist torque command value (step St123 of FIG. 9), the second processing part 16b may obtain the provisional assist torque command value such that, for example, the provisional command value becomes larger as the rotation angle θL of the hip joint (the swing angle θL of the arm 37) becomes larger. In this case, however, when the user merely bends his or her knee a little to change his or her posture and not to perform an action of lifting a load, a rotation angle θL of the hip joint that is larger than zero is obtained and a provisional assist torque command value that is larger than zero is obtained. If the actuator 9 is activated at an output based on this provisional command value, the assist device 10 provides the user with an assist force although the user merely changes his or her posture. This causes the user to have a feeling of discomfort.

In this embodiment, to prevent this situation, the first correspondence information T1 is set such that when the tilt angle θh of the upper body at the start of lifting is smaller than a threshold value, the correction gain is zero or has a value that is larger than zero and sufficiently smaller than 1 (see FIG. 8). Further, the first correspondence information I1 is set such that when the tilt angle θh of the upper body at the start of lifting is equal to or larger than the threshold value, the correction gain becomes larger as the tilt angle θh becomes larger.

According to such first correspondence information I1, even when the user merely changes his or her posture and a provisional assist torque command value that is larger than zero is obtained, since the tilt angle θh of the upper body is small, the correction gain for causing the final assist torque command value τa to approach zero is obtained based on this tilt angle θh. As a result, when the user merely changes his or her posture, the assist torque command value τa is close to zero, which can prevent an assist force from being provided to the user. On the other hand, when the tilt angle θh of the upper body becomes large, the assist torque command value τa can be set to a large value to reduce the burden on the user in lifting a load.

Process for Bowing Action

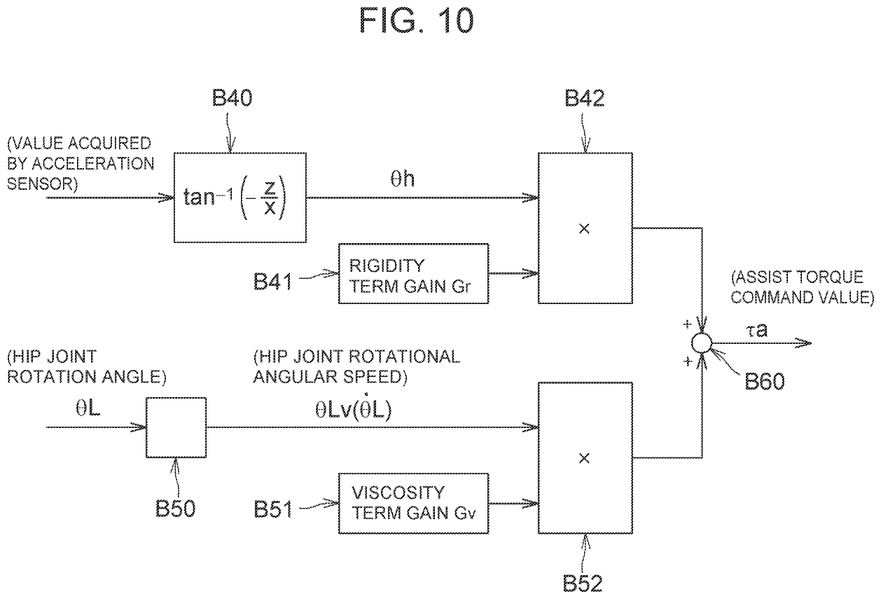

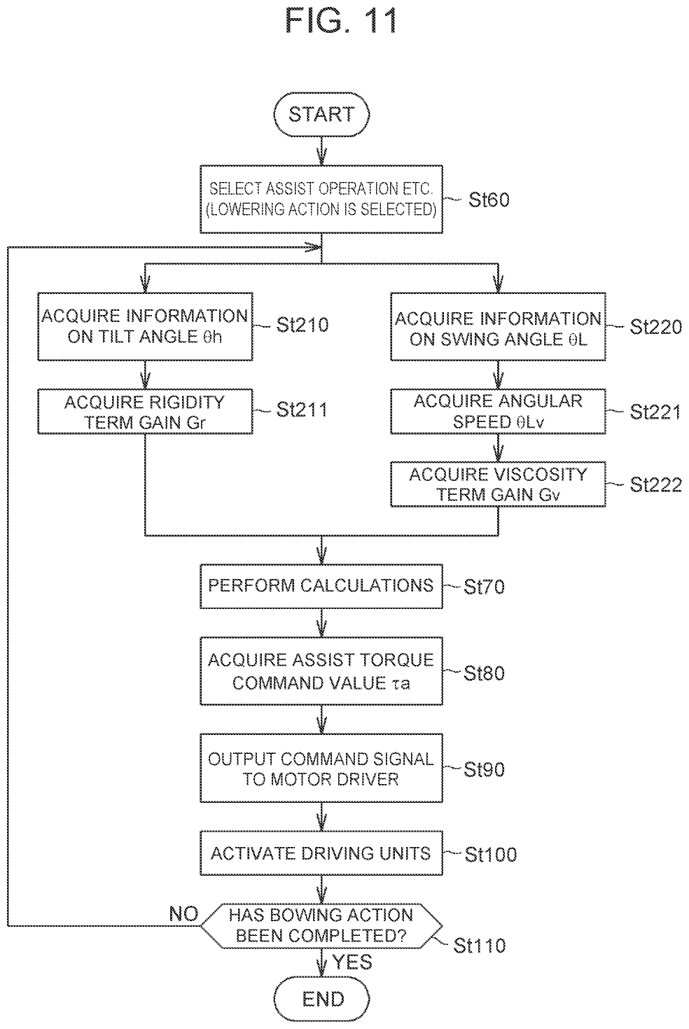

FIG. 10 is a block diagram showing another example of the processes performed by the control device 15, and FIG. 11 is a flowchart showing that example of the processes. The process shown in FIG. 10 and FIG. 11 is a process for bowing. Actions of the user for which the process for a bowing action is performed include an action in which the user assumes a forward leaning posture as shown in FIG. 4 without holding a load, in addition to a lowering action in which the user lowers a load that he or she is holding onto a floor etc. The process for a bowing action is a process of, when the user wearing the assist device 10 performs such an action, providing the user with assist torque. FIG. 10 shows a process of obtaining the command value τa for this assist torque.

Also when the user performs a bowing action, the assist torque generated by the assist device 10 is torque in a direction of changing the posture of the user from a forward leaning posture to an upright standing posture, i.e., torque in a lifting direction. The process for a bowing action is performed when “lowering action” is selected in the operation unit 14 as shown in step St60 of FIG. 11.

As shown in step St80 of FIG. 11, when the command value τa is obtained, as in the case of the lifting action, a command signal for causing the driving units 13R, 13L to output assist torque corresponding to the command value τa is provided to the motor driver 18 (step St90). The motor driver 18 activates the driving units 13R, 13L based on the command signal (step St100). Thus, assist torque is provided to the user.

Also in the process for a bowing action, a process of acquiring the tilt angle information on the tilt angle θh obtained by the triaxial acceleration sensor 33 (step St210), and a process of acquiring the swing angle information on the swing angle θL obtained by the swing angle sensor 52 (step St220) are performed. In this embodiment, the tilt angle information on the tilt angle θh is the tilt angle θh, and the swing angle information on the swing angle θL is the swing angle θL. The assist torque command value τa is obtained based on these pieces of information, i.e., the tilt angle θh and the swing angle θL (step St80), and the driving units 13R, 13L are activated based on the command value τa (step St100). This cycle shown in FIG. 11, i.e., the sequence of processes shown in FIG. 11 is repeatedly performed on a predetermined cycle (e.g., the sequence of processes is performed every 0.001 seconds) until the bowing action (lowering action) is completed. The process for a bowing action for the right driving unit 13R and the process for a bowing action for the left driving unit 13L are the same and concurrently performed.

In FIG. 10, the first processing part 16a acquires the tilt angle θh of the user by calculations based on a detection signal of the triaxial acceleration sensor 33 (block B40 of FIG. 10 and step St210 of FIG. 11). In the case of the process for a bowing action, the tilt angle θh is the tilt angle at that time point.

In FIG. 10, when the swing angle θL (hereinafter referred to as “the rotation angle θL of the hip joint”) is acquired by the swing angle sensor 52, the processing unit 16 obtains the rotational angular speed θLv (block B50 of FIG. 10 and step St221 of FIG. 11). The rotational angular speed θLv is obtained, for example, based on a time-based change in the rotation angle θL of the hip joint.

In the control device 15, a rigidity term gain Gr and a viscosity term gain Gv are set. The values of the rigidity term gain Gr and the viscosity term gain Gv are stored in the storage device (storage part) 17. The values of the rigidity term gain Gr and the viscosity term gain Gv may be preset values (fixed values) or values that vary according to a certain parameter.

In this description, a plurality of values is preset for the rigidity term gain Gr, and one of these values of the rigidity term gain Gr is selected according to the set intensity of assist operation (block B41 of FIG. 10 and step St211 of FIG. 11). Similarly, a plurality of values is set for the viscosity term gain Gv, and one of these values of the viscosity term gain Gv is selected according to the set intensity of assist operation (block B51 of FIG. 10 and step St222 of FIG. 11). The intensity of assist operation is set by the user through the operation unit 14 (selection button) in step St60 of FIG. 11. When “high” is selected in setting the intensity of assist operation, values that make the assist torque command value τa larger are selected as the values of the rigidity term gain Gr and the viscosity term gain Gv than when “low” is selected.

The third processing part 16c multiplies the obtained tilt angle θh by the rigidity term gain Gr (block B42 of FIG. 10 and step St70 of FIG. 11), and multiplies the obtained rotational angular speed θLv by the viscosity term gain Gv (block B52 of FIG. 10 and step St70 of FIG. 11). The rigidity term gain Gr and the viscosity term gain Gv used here are the values selected in blocks B41 and B51 based on the set intensity of assist operation.

The third processing part 16c obtains a sum of the value obtained by multiplying the tilt angle θh by the rigidity term gain Gr and a value obtained by multiplying the rotational angular speed θLv by the viscosity term gain Gv (block B60 of FIG. 10 and step St70 of FIG. 11), and sets the value of the sum as the command value τa for assist torque for the bowing action (step St80 of FIG. 11). Thus, the control device 15 obtains, as the command value τa for assist torque for a bowing action, the sum of a value obtained by applying the rigidity term gain Gr to the obtained tilt angle θh (tilt angle information) and a value obtained by applying the viscosity term gain Gv to the angular speed θLv based on the obtained rotation angle θL. A larger command value τa is obtained as the tilt angle θh is larger (i.e., as the tilt angle θh increases), and a larger command value τa is obtained as the angular speed θLv is higher (as the angular speed θLv increases).

Lifting Action and Bowing Action

As has been described, in this embodiment, the control device 15 can select and perform one of the process for lifting shown in FIG. 8 and FIG. 9 and the process for a bowing action shown in FIG. 10 and FIG. 11. The selection between the two processes is made when the user wearing the assist device 10 operates the operation unit 14 before performing a desired action. Alternatively, this selection may be made by the assist device 10 (control device 15) based on one or both of a detection result of the swing angle sensor 52 and a detection result of the acceleration sensor 33. That is, the action of the user may be determined according to the posture of the user etc., and one of the process for lifting and the process for a bowing action may be selected and performed according to the determined action.

Assist Device 10 of Embodiment

As has been described, in the assist device 10 of this embodiment, both when the user performs a load lifting action and when the user performs a bowing action, the control device 15 obtains the assist torque command value τa based on the swing angle information on the swing angles θL of the arms 37 that represent the angles formed by the upper body and the thighs BF of the user and on the tilt angle information on the tilt angle θh of the upper body of the user that is the upper part of the user's body including his or her hips BW.

In the assist device 10, not only the angles (θL) formed by the upper body and the thighs BF of the user, but also the tilt angle (θh) of the upper body of the user that is the degree of the forward leaning posture of the upper body is taken into account in obtaining the assist torque command value ta. This makes it possible to control the actuator 9 so as to generate no assist torque or, if any, only small assist torque, depending on the tilt angle (θh) of the upper body. As a result, the likelihood of causing the user to have a feeling of discomfort can be reduced.

In the above embodiment, the case where the tilt angle detection part that obtains the tilt angle information on the tilt angle (θh) of the upper body is the triaxial acceleration sensor 33 has been described. However, any other sensor that produces an output that varies according to the posture of the upper body of the user can be used. Further, in the case described above, the swing angle detection parts for the swing angles θL of the arms 37 are the swing angle sensors 52 that detect the rotation angles of the second pulleys 46 serving as rotating members provided in the driving units 13R, 13L. However, any other rotation angle detectors that detect the rotation angles of the rotating members that are provided in the actuator 9 to swing the arms 37 can be used.

Assist Device 10 in Another Form

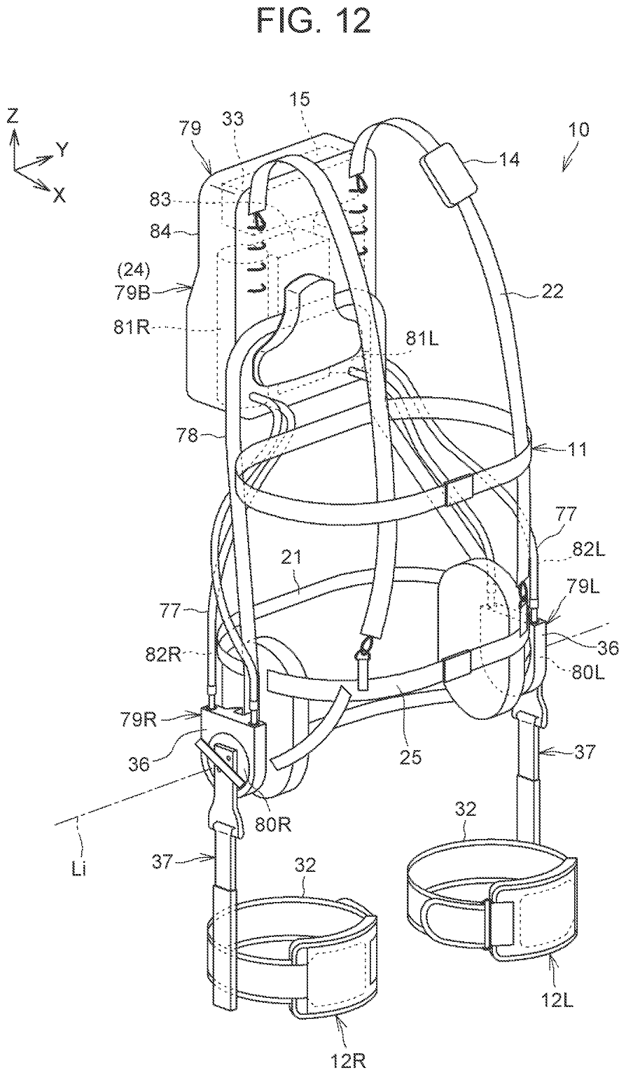

FIG. 12 is a perspective view showing an assist device 10 in another form. This assist device 10 includes a first body-worn unit 11 that is worn on the upper body of the user, right and left second body-worn units 12R, 12L that are worn on the thighs of the right and left legs of the user, and an actuator 79. Those members that have the same function in the assist device 10 shown in FIG. 1 and the assist device 10 shown in FIG. 12 are denoted by the same reference signs.

The actuator 79 includes a power unit 79B that corresponds to the backpack 24 in the form shown in FIG. 1, a left driving unit 79L that is provided so as to correspond to the left side of the hip of the user, and a right driving unit 79R that is provided so as to correspond to the right side of the hip of the user. The power unit 79B and each of the right and left driving units 79R, 79L are coupled together by a frame 78 made of metal or the like. The first body-worn unit 11 is mounted on the actuator 79 including the power unit 79B and the right and left driving units 79R, 79L.

The power unit 79B includes, inside a case 84, a motor 83 and right and left driving pulleys 81R, 81L that are driven to rotate by the motor 83. A triaxial acceleration sensor 33 is provided inside the power unit 79B as a tilt angle detection part that obtains tilt angle information on the tilt angle of the upper body of the user. The left driving unit 79L is provided with a driven pulley 80L inside a case 36. The right driving unit 79R is provided with a driven pulley 80R inside a case 36. Each of the right and left driven pulleys 80R, 80L is provided inside the case 36 so as to be able to turn in one direction and the other direction around an imaginary line Li that passes through the user near his or her hips in the right-left direction. On the left side, a wire 82L is wrapped across the driving pulley 81L and the driven pulley 80L, and on the right side, a wire 82R is wrapped around the driving pulley 81R and the driven pulley 80R. The wires 82R, 82L are respectively housed in guide pipes 77 that are provided between the power unit 79B and the right and left cases 36.

When the right and left driving pulleys 81R, 81L are turned in the one direction by the motor 83, the right and left driven pulleys 80R, 80L are turned in the one direction, with the wires 82R, 82L functioning as power transmission members. When the driving pulleys 81R, 81L are turned in the other direction by the motor 83, the driven pulleys 80R, 80L are turned in the other direction, with the wires 82R, 82L functioning as power transmission members. Arms 37 are respectively mounted on the driven pulleys 80R, 80L, and each of the driven pulleys 80R, 80L moves integrally with the arm 37. The second body-worn units 12R, 12L are mounted at lower parts of the arms 37.

Torque of the right and left arms 37 swinging around the imaginary line Li as a result of turning of the driven pulleys 80R, 80L is provided to the user as assist torque. Thus configured, the actuator 79 performs assist operation of providing the user with an assist force through the first body-worn unit 11 and the second body-worn units 12R, 12L.

The assist device 10 shown in FIG. 12 also includes swing angle detection parts that obtain swing angle information on the swing angles of the arms 37 that represent the angles formed by the upper body and the thighs of the user. The swing angle detection parts are sensors (e.g., encoders or angle sensors) that detect the rotation angles of the driven pulleys 80R, 80L that move integrally with the arms 37. Since the rotation angle of the driven pulley 80L (80R) and the rotation angle of the driving pulley 81L (81R) are correlated with each other, the swing angle detection part may be configured to obtain the swing angle information on the swing angle of the arm 37 based on the rotation angle of the driving pulley 81L (81R).

Like the assist device 10 shown in FIG. 1, the assist device 10 shown in FIG. 12 also includes a control device 15 that performs a process for lifting and a process for bowing. As in the assist device 10 shown in FIG. 1, the control device 15 obtains the command value for assist torque for a lifting action or a bowing action based on the swing angle information on the swing angles θL of the arms 37 that represent the angles formed by the upper body and the thighs of the user and on the tilt angle information on the tilt angle θh of the upper body of the user including his or her hips BW. Specific examples of processes are the same as the processes shown in FIG. 8 to FIG. 11, and therefore the description thereof will be omitted here.

Also in the assist device 10 shown in FIG. 12, the control device 15 obtains the assist torque command value as an assist parameter based on the swing angle information and the tilt angle information. Not only the angles formed by the upper body and the thighs of the user (swing angle information), but also the tilt angle that is the degree of the forward leaning posture of the upper body of the user (tilt angle information) is taken into account in obtaining the assist torque command value. This makes it possible to control the actuator 9 so as to generate no assist torque or, if any, only small assist torque, depending on the tilt angle of the upper body. As a result, the likelihood of causing the user to have a feeling of discomfort can be reduced.

The mechanisms of the respective parts of the assist device 10 may have configurations different from those shown in the drawings. For example, the first body-worn unit 11 may have a form different from that shown in the drawings, as long as it is configured to be worn at least on the hips BW of the user. The second body-worn units 12R, 12L may have forms different from those shown in the drawings, as long as they are configured to be worn on the thighs BF of the right and left legs of the user. The configuration of the actuator 9 may also be different, as long as it includes the arms 37 that provide the user with assist torque by swinging back and forth.

The embodiment disclosed this time is in every respect merely illustrative and not restrictive. The scope of the right for the present disclosure is not limited to the above embodiment and includes all changes within a scope equivalent to the configuration described in the claims.

What is claimed is:

1. An assist device comprising:
a first body-worn unit that is worn at least on hips of a user;
second body-worn units that are worn on thighs of right and left legs of the user;
an actuator that includes driving units mounted on the first body-worn unit so as to be located on right and left sides of the hips of the user, the actuator being configured to generate assist torque that assists the user in moving the hips of the user relatively to the thighs of the user and moving the thighs of the user relatively to the hips of the user;
a controller configured to obtain an assist parameter that determines the assist torque to be generated, and perform control to operate the actuator at an output based on the assist parameter; and
a tilt angle detection part configured to obtain tilt angle information on a tilt angle of an upper body of the user,
wherein the actuator includes:
arms each of which has a leading end mounted on a corresponding one of the second body-worn units and a base end mounted on a corresponding one of the driving units, each of the arms being configured to swing back and forth around the base end; and
swing angle detection parts configured to obtain swing angle information on swing angles of the arms that represent angles formed by the upper body and the thighs of the user, and
wherein the controller is configured to obtain the assist parameter based on the swing angle information and the tilt angle information.

2. The assist device according to claim 1, wherein the controller is configured to obtain a provisional assist parameter based on the swing angle information, obtain a correction gain based on the tilt angle information, and obtain the assist parameter using the provisional assist parameter and the correction gain.

3. The assist device according to claim 2, wherein a value of the correction gain obtained by the controller is a value that makes the assist parameter larger when the tilt angle is large than when the tilt angle is small.

4. The assist device according to claim 2, wherein the controller is configured to, when the tilt angle is small, obtain the correction gain for causing the assist parameter to approach zero, based on the tilt angle information on the tilt angle.

5. The assist device according to claim 2, wherein the controller includes:
a counting part configured to obtain a lifting duration time indicating an elapsed time since the user starts to lift a load;
a storage part configured to store first correspondence information that indicates a relation between the tilt angle information and the correction gain and second correspondence information that indicates a relation between the lifting duration time and the provisional assist parameter;
a first processing part configured to obtain the correction gain based on the obtained tilt angle information and the first correspondence information; and
a second processing part configured to obtain the provisional assist parameter based on the obtained lifting duration time and the second correspondence information.

6. The assist device according to claim 1, wherein the controller is configured to obtain, as the assist parameter, a sum of a value that is obtained by applying a rigidity term gain to the obtained tilt angle information and a value that is obtained by applying a viscosity term gain to the obtained swing angle information.

7. The assist device according to claim 2, wherein:
a process in which the controller obtains the assist parameter using the correction gain is a process for lifting;
a process in which the controller obtains, as the assist parameter, a sum of a value that is obtained by applying a rigidity term gain to the obtained tilt angle information and a value that is obtained by applying a viscosity term gain to the obtained swing angle information is a process for a bowing action; and
the controller is configured to select and perform one of the process for lifting and the process for the bowing action.

8. The assist device according to claim 1, wherein:
the tilt angle detection part is a sensor configured to produce an output that varies according to a posture of the upper body of the user; and
the swing angle detection parts are detectors configured to detect rotation angles of rotating members provided in the actuator to swing the arms.
